(19) United States
(12) Patent Application Publication
(10) Pub. No.: US 2024/0256657 A1
(43) Pub. Date: Aug. 1, 2024

(54) SYSTEM AND METHOD FOR INTRUSION DETECTION IN MODULAR SYSTEMS

(71) Applicant: Dell Products L.P., Round Rock, TX (US)

(72) Inventors: TIMOTHY M. LAMBERT, Austin, TX (US); MILTON OLAVO DECARVALHO TAVEIRA, Round Rock, TX (US)

(21) Appl. No.: 18/159,899

(22) Filed: Jan. 26, 2023

(51) Int. Cl. G06F 21/55

(52) U.S. Cl. CPC G06F 21/554; G06F 2221/034

(57) ABSTRACT

Methods and systems for managing operation of data processing systems are disclosed. The data processing systems may be modularized, and include disconnection monitoring systems. The disconnection monitoring systems may monitor connections between modules of the data processing systems. When a disconnection event occurs, a disconnection monitoring system may log when the event occurred, and may report the event and time of the event to management entities such as management controllers and processing complexes.

### FIELD

Embodiments disclosed herein relate generally to operation management. More particularly, embodiments disclosed herein relate to systems and methods to manage risks to data processing systems.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show diagram illustrating a disconnection monitoring system of a data processing system in accordance with an embodiment.

FIG. 3 shows a flow diagram illustrating a method of managing the operation of data processing systems in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems. To provide flexibility in implementation, the data processing systems may be modularized. The modules of the data processing system may provide respective functionalities such as processing functionality, security functionality, management functionality, etc. Thus, specific functionalities may be achieved by incorporating a modules that includes the specific functionalities into a data processing system.

However, modularization may present risk to a data processing system. A malicious party may replace modules with compromised modules (e.g., that perform various undesired operation that may facilitate unauthorized access to data, and/or other undesired outcomes) to compromise the data processing system. Further, interconnections between the modules may be snooped to allow a malicious party to obtain sensitive data or inject malicious data.

To reduce risk of compromise or otherwise undesired operation, a data processing system may include a disconnection monitoring system. The disconnection monitoring system may monitor for disconnection events between modules of data processing systems. When disconnection events are identified, the disconnection monitoring system may report occurrences of the disconnection events to other portions of the data processing system. For example, management controllers and/or processing complexes may receive separate reports thereby allowing for various actions to be performed to reduce the impact of potential malicious activity thereby managing threats presented to a data processing system.

By doing so, a data processing system in accordance with an embodiment may be more likely to be able to provide desired computer implemented services with reduced risk of compromise. For example, by actively monitoring for disconnection events between modular components, risks may be proactively mitigated through performance of actions sets when disconnection events are identified.

In an embodiment, a method for managing operation of data processing systems is provided. The method may include, during a first period of time while a data processing system of the data processing systems is inactive: identifying, using disconnect circuitry and a monitoring device, an occurrence of a detachment of a secure control module of the data processing system from a host processor module of the data processing system; identifying a time for the occurrence; during a second period of time while the data processing system is active: providing, based on the occurrence and the time, a first report to a processing complex of the data processing system, the first report indicating that an intrusion has occurred; providing, based on the occurrence and the time, a second report to a management controller of the data processing system, the second report indicating that the intrusion has occurred; and performing a first action set based on at least one of the first report and the second report to mitigate a threat presented by the intrusion.

The first report and the second report may be provided by the monitoring device, the host processor module may include the processing complex, and the secure control module may include the management controller.

The method may also include, during a third period of time: monitoring a power level of a backup power supply used to operate the disconnect circuitry and the monitoring device; and obtaining, from the monitoring device, an indication that the monitoring device has reset; and, in a first instance of the monitoring where the power level exceeds a threshold:
performing a second action set to mitigate a threat presented by a second intrusion.

The method may also include, during the third period of time: in a second instance of the monitoring where the power level does not exceed the threshold: performing a third action set based on a conclusion that the backup power supply ran out of power.

The backup power supply may include a battery, and the disconnect circuitry and the monitoring device may be redundantly powered by the backup power supply and a power supply of the data processing system.

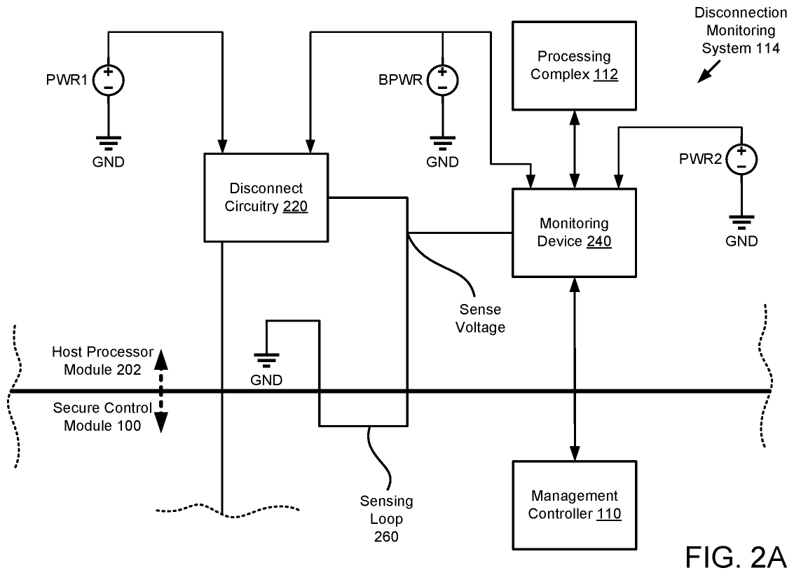

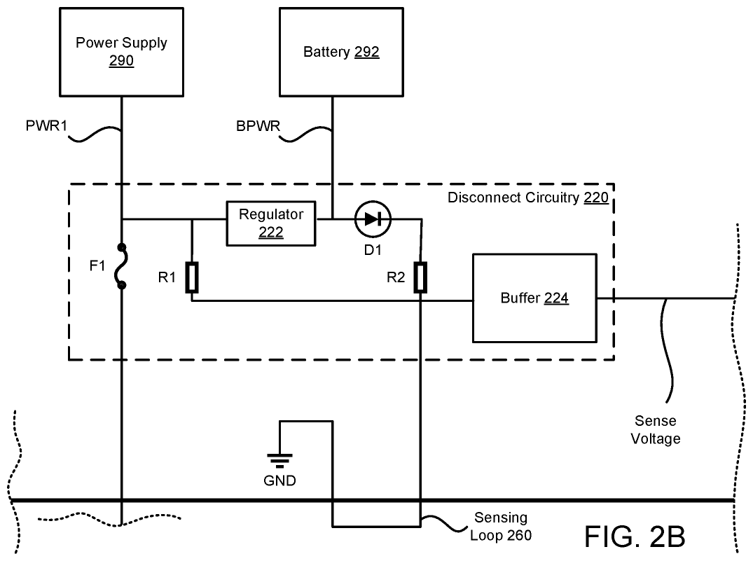

The disconnection circuitry may include a sensing loop distributed over the host processor module and the secure control module. While illustrated in FIG. 2A as being separate, the sensing loop may be part of the disconnect circuitry.

The first action set may be performed by the secure control module, and the method may also include performing, by the host processing module, a second action set based on at least one of the first report and the second report to mitigate the threat presented by the intrusion.

The first action set and the second action set may be different from one another.

In an embodiment, a non-transitory media is provided. The non-transitory media may include instructions that when executed by a processor cause the method to be performed.

In an embodiment, a data processing system is provided. The data processing system may include the non-transitory media, a secure control module, a host processor module, and a processor, and may perform the method when the computer instructions are executed by the processor.

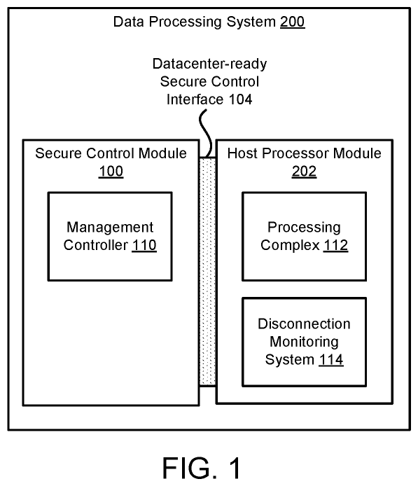

Turning to FIG. 1, a block diagram illustrating a system in accordance with an embodiment is shown. The system shown in FIG. 1 may provide computer implemented services. The computer implemented services may include any type and quantity of computer implemented services. For example, the computer implemented services may include data storage services, instant messaging services, database services, and/or any other type of service that may be implemented with a computing device.

To provide the computer implemented services, the system may include any number of data processing system 200. Data processing system 200 may provide the computer implemented services to users of data processing system 200 and/or to other devices (not shown).

To provide the computer implemented services, data processing system 200 may include various hardware components (e.g., processors, memory modules, storage devices, etc.) and host various software components (e.g., operating systems, application, startup managers such as basic input-output systems, etc.). These hardware and software components may provide the computer implemented services via their operation.

Data processing system 200 may be modularized. Hardware devices of data processing system 200 that provide different functionalities may be grouped into interchangeable modules. For example, data processing system 200 may include secure control module 100 and host processor module 202.

Host processor module 202 may provide processing functionality (e.g., by including processing complex 112 which may include processors, memory modules, field programmable gate arrays, and/or other types of special purpose hardware devices, etc.) while secure control module 100 may provide management and/or security functionality (e.g., when data processing system 200 is used as a block in a computing environment such as a data center, and may include hardware components such as field programmable gate arrays and/or other types of special purpose hardware devices such as management controller 110). Data processing system 200 may include any number and type of modules that provide different or similar functionalities.

The modules may be operably connected to one another via any method. For example, a module may be implemented using a circuit card or other types of hardware component interconnection devices. The module may also include one or more connectors such as datacenter-ready secure control interface 104 that allow the module to interface (e.g., establish operable connections) with other modules. The provided interfaces may facilitate exchange of data between the module, distribution of power, and/or other functionalities. For example, a power supply (not shown) may provide power to host processor module 202, which may in turn provide some of the power to secure control module 100 while operably connected via datacenter-ready secure control interface 104.

The modularized approach may allow for efficient reconfiguration of data processing systems, expansion, and/or otherwise facilitate adaptation of data processing system 200 for various uses. For example, various modules may be added, removed, and/or replaced.

However, the modularized approach may also present risk to desired operation of data processing system 200. Sensitive information may be transmitted between the modules via datacenter-ready secure control interface 104 thereby allowing a malicious party to access the sensitive information if physical access to the modules of data processing system 200 is available. Additionally, the modularized approach may allow a malicious party to replace a module with a malicious module. The malicious module may act like an authentic module, but may provide for eavesdropping, facilitate zero-day attacks, access sensitive information (e.g., such as debug information for processors of processing complex 112 which may allow even secured information to be accessed).

In general, embodiments disclosed herein may provide methods, systems, and/or devices for managing operation of data processing systems. To manage the operation of data processing systems, data processing system 200 may include disconnect monitoring system 114. Disconnect monitoring system may provide for monitoring of the physical connection (e.g., datacenter-ready secure control interface 104) between modules of data processing system 200. The connection may be monitored to identify occurrences of disconnection events that may indicate that malicious activity has occurred which may place data processing system 200 in a compromised state.

When disconnection events are identified, disconnection monitoring system 114 may report the events to multiple management entities. For example, disconnection monitoring system 114 may provide reports of the events to both management controller 110 and processing complex 112. These entities may separately investigate and/or take other actions with respect to the reports. For example, in response to an occurrence of a disconnection report, these entities may (i) gather additional information regarding the state of data processing system 200 (e.g., from intrusion sensors that monitoring opening/closing of portions of chassis of data processing system 200 that house the modules), (ii) gather information regarding the states of backup systems (e.g., such as backup power used by disconnection monitoring system 114 to remain active even while data processing system 200 is inactive/unpowered), (iii) use all of the gathered information to ascertain whether malicious action has occurred, and/or (iv) take action responsive to the malicious action to reduce potential impacts of the malicious action. By doing so, the security of data processing system 200 may be improved.

Disconnection monitoring system 114 may be implemented with circuitry. While illustrated as being part of host processor module 202, disconnection monitoring system 114 may be part of any module of data processing system 200 and/or may be distributed across multiple modules. Refer to FIGS. 2A-2B for additional details regarding disconnection monitoring system.

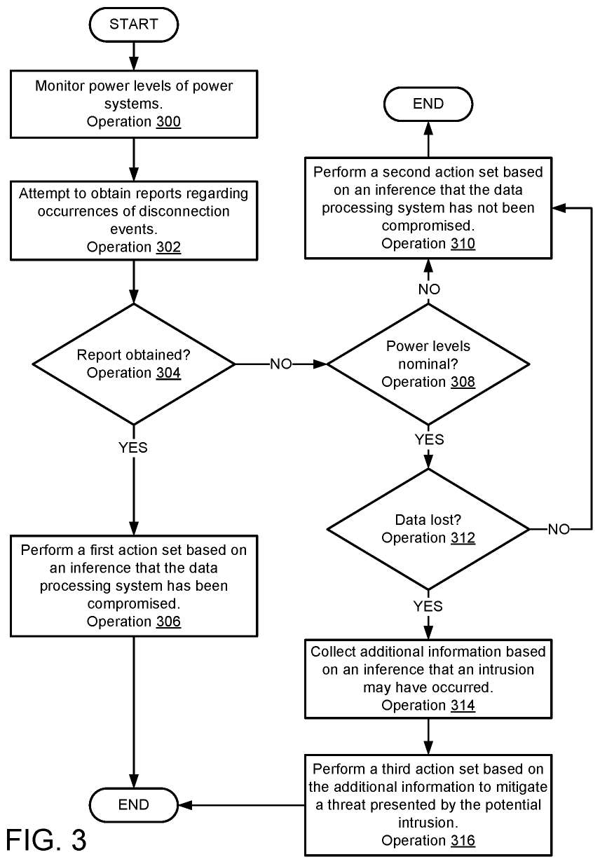

When providing its functionality, data processing system 200, or components thereof, may perform all, or a portion, of the method illustrated in FIG. 3.

Management controller 110 may be implemented using an in-band or out-of-band management controller. Management controller 110 may be implemented using, for example, a system on a chip or assembly, and may be operably connected to but may operate independently from secure control module 100 and/or operably connected components such as host processor module 202. Management controller 110 may include functionality to, for example, communicate with other hardware components via out-of-band channels thereby allowing management controller 110 to reconfigure, flash, and/or otherwise modify the operation of the other hardware components.

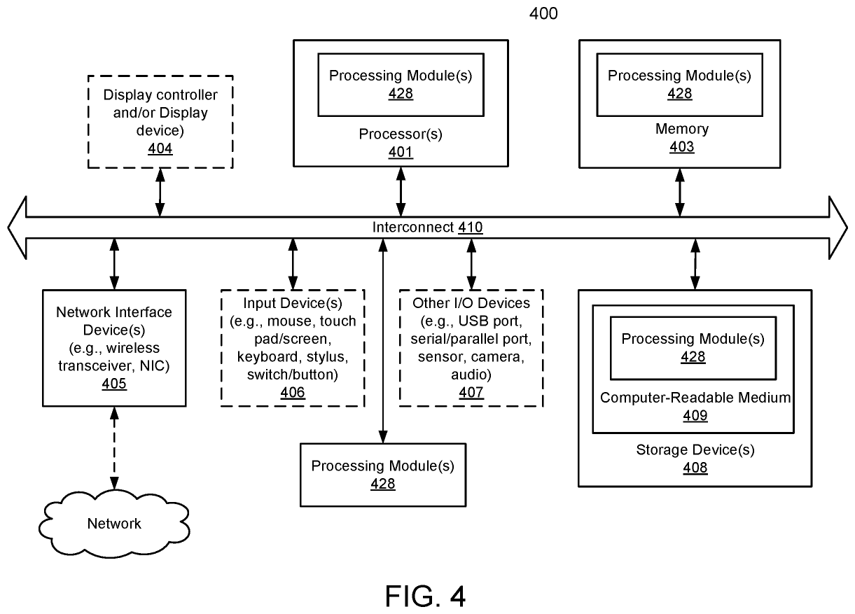

Data processing system 200 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

While illustrated in FIG. 1 as including a limited number of specific components, a system in accordance with an embodiment may include fewer, additional, and/or different components than those illustrated therein.

To further clarify systems in accordance with embodiments, diagrams in accordance with an embodiment are shown in FIGS. 2A-2B that shows portions of a data processing system. In FIGS. 2A-2B, wavy dashed lines are used to indicate that the diagrams may continue on beyond the portions illustrated in these figures.

Turning to FIG. 2A, a first diagram illustrating a portion of modules of data processing system 200 in accordance with an embodiment is shown.

To identify occurrences of disconnection events, disconnection monitoring system 114 may be utilized. As seen in FIG. 2A, disconnection monitoring system 114 may be distributed, in part, across host processor module 202 and secure control module 100. In FIG. 2A, the distribution across the modules is illustrated using the line from which the arrows having dashed tails originate delineates. The components above the line may be with host processor module 202 and the components below the line may be with secure control module 100. For example, in a scenario in which the modules are implemented using respective circuit cards, the line may represent a connector interconnecting the two modules.

To identify occurrences of disconnection events, disconnection monitoring system 114 may include disconnect circuitry 220, monitoring device 240, and sensing loop 260. Each of these components are discussed below.

Disconnect circuitry 220 may present a voltage (e.g., sense voltage) that reflects when host processor module 202 and secure control module 100 are disconnected from one another. For example, disconnect circuitry 220 may include circuitry that is redundantly powered by a power supply of a host data processing system and a backup power system. The power supply may power the modules by providing conditioned power of various voltage and current levels to different modules and/or portions thereof.

For example, the power supply may output a 12 Volt voltage (e.g., PWR1 in FIG. 2A) and a 3.3 Volt voltage (e.g., PWR2 in FIG. 2A). Likewise, the backup power system may also output various levels of power or only a single voltage.

The power supply may be implemented using any type of power supply. The backup power system may be implemented with a battery backup system. For example, the battery backup system may include a battery that nominally outputs a 3.0 Volt voltage (e.g., BPWR in FIG. 2A).

Disconnect circuitry 220 may be connected to sensing loop 260. Sensing loop 260 may be implemented with a wire loop (e.g., a circuit card trace distributed across two circuit cards used to implement the respective modules that includes a connector as part of the loop). Sensing loop 260 may be connected to a ground (e.g., designated as GND in FIG. 2A) and disconnect circuitry 220.

When secure control module 100 and host processor module 202 are disconnected, sensing loop 260 may open circuit thereby disconnecting the ground from disconnect circuitry. The open circuit may cause sense voltage to change voltage levels (e.g., increase or decrease, thereby establishing a signal linked to disconnection events).

Refer to FIG. 2A for additional details regarding disconnect circuitry 220.

Monitoring device 240 may monitor sense voltage and identify disconnection events based on changes in the voltage. When an disconnection event is identified, monitoring device 240 may record the occurrence of the disconnection event, and a time of the disconnection event.

Monitoring device 240 may notify processing complex 112 and management controller 110 of occurrences of disconnection events and times of the occurrences. For example, once recorded, monitoring device 240 may wait until these components are active (may not be active at all points in time such as when unpowered), and may provide information based on the records when active.

Like disconnect circuitry 220, monitoring device 240 may be redundantly powered by both the power supply and the battery backup system. Consequently, so long as the battery backup system remains operations, monitoring device 240 may maintain records of disconnection events (e.g., unless instructed by processing complex 112 or management controller 110 to flush records).

Monitoring device 240 may be implemented using, for example, a microchip. The microchip may include real-time clock functionality (e.g., to identify times of occurrences of disconnection events), analog to digital conversion functionality (e.g., to convert sense voltage to digital representation usable by digital logic devices, communication functionality (e.g., such as I2C communication protocol compliance used to communicate with processing complex 112 and/or management controller 110), and/or other functionalities.

Turning to FIG. 2B, a second diagram illustrating a portion of modules of data processing system 200 in accordance with an embodiment is shown.

To establish an electrical signal usable to identify disconnection events, disconnect circuitry 220 may include fuse F1, resistors R1-R4, regulator 222, diodes D1-D2, and buffer 224. Each of these components is discussed below.

Fuse F1 may be an electronic fuse usable to electrically disconnect secure control module 100 from power supply 290 (e.g., in the vent that secure control module draws more power than desired/expected).

Regulator 222 may modify the voltage level of PWR1 to match the voltage level of BPWR while battery 292 has capacity to supply nominal amount of power. For example, regulator 222 may reduce the voltage level of PWR1 to 3.3 Volts, which battery 292 may also provide. Power supply 290 may supply 12 Volts (e.g., PWR1) to disconnect circuitry 220.

Diodes D1-D2 may serve as an OR gate that ensures that the voltage level that is provided to buffer 224 and resistor R2 is 3.0 Volts (e.g., so long as power supply 290 or battery 292 are outputting voltage as expected). Resistor R4 may provide a degree of voltage division with respect to R2 and buffer 224 (e.g., to manage the voltage at the node interconnecting the diodes, buffer 224, and R2).

Buffer 224 may buffer the output voltage (e.g., sense voltage) from disconnect circuitry 220. Consequently, changes in the output voltage may be better sensed (e.g., by reducing transitory effects).

The values of the resistors R1-R3 may be selected based on the operational range of buffer 224. For example, the values of the resistors may be selected so that the input voltage to buffer 224 is within a range compatible with buffer 224.

While sensing loop is closed, current may be drawn to the ground thereby placing the input voltage to buffer 224 at a first voltage level. When sensing loop 260 opens (e.g., coinciding with an disconnection event), current may no longer be drawn to ground thereby modifying voltage level (e.g., raising it) presented to the input of buffer 224. Consequently, the sense voltage presented to monitoring device 240 may change (e.g., rise/fall) thereby allowing for detection of disconnection events.

While illustrated in FIGS. 2A-2B using specific components, a disconnection monitoring system may include additional, different, and/or fewer components without departing from embodiments disclosed herein.

Additionally, while illustrated using circuit elements that modify changes in resistance in response to disconnection events (e.g., by sensing loop 260 open circuiting), the circuit elements may modify other characteristics in response to disconnection events without departing from embodiments disclosed herein. For example, capacitive or inductive sensing may be utilized to identify occurrences of disconnection events.

As discussed above, the components of FIG. 1 may perform various methods to provide computer implemented services by completing startups (e.g., which may be required to be completed for the computer implemented services to be provided. FIG. 3 illustrates a method that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for manage operation of a data processing system in accordance with an embodiment is shown. The method may be performed by data processing system 200, management controller 110, processing complex 112, and/or other components of the system shown in FIG. 1.

At operation 300, an occurrence of a powering of a secure control module is identified. The identification may be made by identifying that a management controller is receiving power from a power manager of the secure control module.

At operation 300, power levels of power systems are monitored. The power levels may be monitored by monitoring voltage levels of various voltages provided by power supplies and/or backup power systems. The voltage levels may be compared to nominal levels to identify whether the power levels are nominal. For example, the voltage levels may be compared to thresholds to identify whether the power levels are nominal.

The power levels may be monitored over time. For example, discrete measurements of the voltage levels may be made at different points in time.

At operation 302, attempts to obtain reports regarding occurrences of disconnection events are made. The attempts may be made (i) by sending requests for the reports, (ii) automatically (e.g., a monitoring device may automatically send them to the management controller and processing complex when a report is available), and/or (iii) via other methods.

At operation 304, a determination is made regarding whether a report is obtained. If a report is obtained in operation 302, then the method may proceed to operation 306. Otherwise, the method may proceed to operation 306.

At operation 306, a first action set is performed based on an inference that a data processing system has been compromised. The first action set may include any number and types of actions. For example, the first action set may include (i) sending notifications to administrator, (ii) suspending or otherwise limiting operation of the data processing system, and/or (iii) other actions. The action set may mitigate a threat presented by an intrusion to the data processing system.

The method may end following operation 306.

Returning to operation 304, the method may proceed to operation 308 when no reports are obtained.

At operation 308, a determination is made regarding whether the power levels monitored duration operation 300 are nominal. The determination may be made by comparing the monitored power levels to thresholds that discriminate nominal for reduced power levels.

If it is determined that the power levels are nominal, then the method may proceed to operation 312 following operation 308. Otherwise the method may proceed to operation 310.

At operation 310, a second action set is performed based on an inference that the data processing system has not been compromised. For example, it may be inferred that no report is available due to lack of power.

The second action set may include any number and types of actions. For example, the second action set may include (i) resetting operation of components of a disconnection monitoring system (e.g., by writing some security data to a monitoring device), (ii) storing information indicating the data processing system is secure, and/or (iii) other actions. The action set may place the disconnection monitoring system in condition to detect future intrusions.

The method may end following operation 310.

Returning to operation 308, the method may proceed to operation 312 when power levels are nominal.

At operation 312, a determination is made regarding whether data has been lost from the disconnection monitoring system. The determination may be made by attempting to read the information previously stored during operation 310. For example, a security code or other data structure may be stored in a monitoring device during operation 310. Once stored, the data may be stored persistently until deleted (e.g., due to the monitoring device being wiped by a malicious intruder).

If data loss has not occurred, then the method may proceed to operation 310. Otherwise the method may proceed to operation 314.

At operation 314, additional information is collected based on an inference that an intrusion may have occurred (e.g., based on the data loss). The additional information may be collected from various intrusion devices that may monitor accesses into a chassis of a data processing system. The additional information may indicate whether any of the accesses were opened. The intrusion devices may include, for example, bump sensor, distance sensors, and/or other types of sensors to monitor changes in the configuration of the chassis, such as panels being removed, hatches being opened, etc.

At operation 316, a third action set is performed based on the additional information. The third action set may mitigate a threat presented by the potential intrusion. The third action set may include (i) sending notifications to administrator, (ii) suspending or otherwise limiting operation of the data processing system, and/or (iii) other actions.

The method may end following operation 306.

Using the method illustrated in FIG. 3, disconnections of modules of a data processing system may be identified. The disconnections may be used to mitigate potential malicious activity. For example, actions sets that limit the impact of potential malicious activity may be performed responsive to identifications that disconnection events have occurred.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of data processing systems, the method comprising:
during a first period of time while a data processing system of the data processing systems is inactive:
identifying, using disconnect circuitry and a monitoring device, an occurrence of a detachment of a secure control module of the data processing system from a host processor module of the data processing system;
identifying a time for the occurrence;
during a second period of time while the data processing system is active:
providing, based on the occurrence and the time, a first report to a processing complex of the data processing system, the first report indicating that an intrusion has occurred;
providing, based on the occurrence and the time, a second report to a management controller of the data processing system, the second report indicating that the intrusion has occurred; and
performing a first action set based on at least one of the first report and the second report to mitigate a threat presented by the intrusion.

2. The method of claim 1, wherein the first report and the second report are provided by the monitoring device, the host processor module comprises the processing complex, and the secure control module comprises the management controller.

3. The method of claim 1, further comprising:
during a third period of time:
monitoring a power level of a backup power supply used to operate the disconnect circuitry and the monitoring device; and
obtaining, from the monitoring device, an indication that the monitoring device has reset; and
in a first instance of the monitoring where the power level exceeds a threshold:
performing a second action set to mitigate a threat presented by a second intrusion.

4. The method of claim 3, further comprising:
during the third period of time:
in a second instance of the monitoring where the power level does not exceed the threshold:
performing a third action set based on a conclusion that the backup power supply ran out of power.

5. The method of claim 4, wherein the backup power supply comprises a battery, and the disconnect circuitry and the monitoring device are redundantly powered by the backup power supply and a power supply of the data processing system.

6. The method of claim 5, wherein the disconnect circuitry comprises a sensing loop distributed over the host processor module and the secure control module.

7. The method of claim 1, wherein the first action set is performed by the secure control module, and the method further comprises:
performing, by the host processing module, a second action set based on at least one of the first report and the second report to mitigate the threat presented by the intrusion.

8. The method of claim 7, wherein the first action set and the second action set are different from one another.

9. A non-transitory machine-readable medium having instructions stored therein, which when executed by a processor, cause the processor to perform operations for managing operation of data processing systems, the operations comprising:
during a first period of time while a data processing system of the data processing systems is inactive:
identifying, using disconnect circuitry and a monitoring device, an occurrence of a detachment of a secure control module of the data processing system from a host processor module of the data processing system;
identifying a time for the occurrence;
during a second period of time while the data processing system is active:
providing, based on the occurrence and the time, a first report to a processing complex of the data processing system, the first report indicating that an intrusion has occurred;
providing, based on the occurrence and the time, a second report to a management controller of the data processing system, the second report indicating that the intrusion has occurred; and
performing a first action set based on at least one of the first report and the second report to mitigate a threat presented by the intrusion.

10. The non-transitory machine-readable medium of claim 9, wherein the first report and the second report are provided by the monitoring device, the host processor module comprises the processing complex, and the secure control module comprises the management controller.

11. The non-transitory machine-readable medium of claim 9, wherein the operations further comprise:
during a third period of time:
monitoring a power level of a backup power supply used to operate the disconnect circuitry and the monitoring device; and
obtaining, from the monitoring device, an indication that the monitoring device has reset; and
in a first instance of the monitoring where the power level exceeds a threshold:
performing a second action set to mitigate a threat presented by a second intrusion.

12. The non-transitory machine-readable medium of claim 11, wherein the operations further comprise:
during the third period of time:
in a second instance of the monitoring where the power level does not exceed the threshold:
performing a third action set based on a conclusion that the backup power supply ran out of power.

13. The non-transitory machine-readable medium of claim 12, wherein the backup power supply comprises a battery, and the disconnect circuitry and the monitoring device are redundantly powered by the backup power supply and a power supply of the data processing system.

14. The non-transitory machine-readable medium of claim 13, wherein the disconnect circuitry comprises a sensing loop distributed over the host processor module and the secure control module.

15. The non-transitory machine-readable medium of claim 9, wherein the first action set is performed by the secure control module, and the operations further comprise:
performing, by the host processing module, a second action set based on at least one of the first report and the second report to mitigate the threat presented by the intrusion.

16. The non-transitory machine-readable medium of claim 15, wherein the first action set and the second action set are different from one another.

17. A data processing system, comprising:
a secure control module;
a host processor module
a disconnection monitoring system adapted to;
during a first period of time while the secure control module and the host processor module are inactive:
identifying an occurrence of a detachment of the secure control module from the host processor module;
identifying a time for the occurrence;
during a second period of time while the secure control module and the host processor module are active:
providing, based on the occurrence and the time, a first report to a processing complex of the host processor module, the first report indicating that an intrusion has occurred; and
providing, based on the occurrence and the time, a second report to a management controller of the secure control module, the second report indicating that the intrusion has occurred,
wherein the processing complex and the management controller are adapted to perform actions sets based on the first report or the second report to mitigate a threat presented by an intrusion of the data processing system.

18. The data processing system of claim 17, wherein the disconnect monitoring system comprises:
a monitoring device adapted to identify the occurrence based on a voltage; and
disconnect circuitry adapted to modulate the voltage based on a connection state of the secure control module and the host processor module.

19. The data processing system of claim 18, wherein the disconnect circuitry comprises:
a sensing loop distributed over the host processor module and the secure control module.

20. The data processing system of claim 18, further comprising:
a power supply; and
a backup power supply comprising a battery,
wherein the disconnect circuitry and the monitoring device are redundantly powered by the backup power supply and the power supply.
